(19) United States
(12) Patent Application Publication
(10) Pub. No.: US 2007/0271838 A1
(43) Pub. Date: Nov. 29, 2007

(54) Fish-Hook Top

(76) Inventor: Arkadiusz Lowiecki, Slubice (PL)

Correspondence Address: MATTHIAS SCHOLL, 14781 MEMORIAL DRIVE, SUITE 1319, HOUSTON, TX, 77079, US

(21) Appl. No.: 10/595,296

(22) PCT Filed: Aug. 9, 2004
(86) PCT No.: PCT/PL04/00062

§ 371 Date: Feb. 10, 2007

(30) Foreign Application Priority Data
Aug. 9, 2004 (PL) PCT/PL04/00062
Sep. 5, 2003 (PL) P.362012

(51) Int. Cl. A01K 85/00; A01K 97/24

(52) U.S. Cl. 43/42.39; 43/44.81; 43/17.2; 43/42.72

(57) ABSTRACT

The subject of the invention is a jig head used in spin fishing. According to the invention, the jig head comprises two symmetrical cut-off surfaces (3) and (3′) in the spherical part (1) of the hemisphere at both sides of the hook eye (4), whereas planes parallel to the cut-off surfaces intersect at an angle ranging from 65° to 30° and a cutting blade (5) is attached at their intersection. In addition, the jig head might be equipped with a spring (6) centrically embracing the hook (7), which at its one end is fixed to the bearing (8) which in turn is connected to the head via a bushing (9).

The subject of the invention is a jig head used in spin fishing.

Known are jig heads, for example those made by “Owner”, having extended hook shanks and a reduced hook bend. A longer shank enables the placement of the hook point close to the agile part of the bait.

Jig heads made by Jaxon are available in a wide variety of sizes, from the smallest to the largest.

In order to enable fast and easy movement of the jig head between aquatic plants, and to fasten the bait securely, a jig head having a cutting blade and a spring is proposed.

According to the invention, the jig head comprises a hemisphere having two symmetrical cut-off surfaces in the spherical cap, disposed at both sides of the shank end. Both cut-off surfaces are disposed at the highest point of the hemisphere of the jig head and are oriented in such a way that planes parallel to the cut-off surfaces intersect one another at an angle ranging from 65° to 30°, and preferably from 55° to 40°. At the intersection of planes parallel to the cut-off surfaces, disposed is a cutting blade having a length not larger than the head's diameter and extending to the eye of the hook.

It is advantageous to make the cut-off surfaces slightly concave in order to obtain better dynamic parameters.

The jig head optionally comprises a spring which centrically embraces the hook of the jig head. The spring is attached at one end to a bearing which in turn is connected to the head via a bushing.

The jig head of this construction moves through water with aquatic plants without problems because it cuts the plants which substantially improves fishing conditions.

Furthermore, due to its rotation, the spring fastens the bait securely preventing slipping while casting the set.

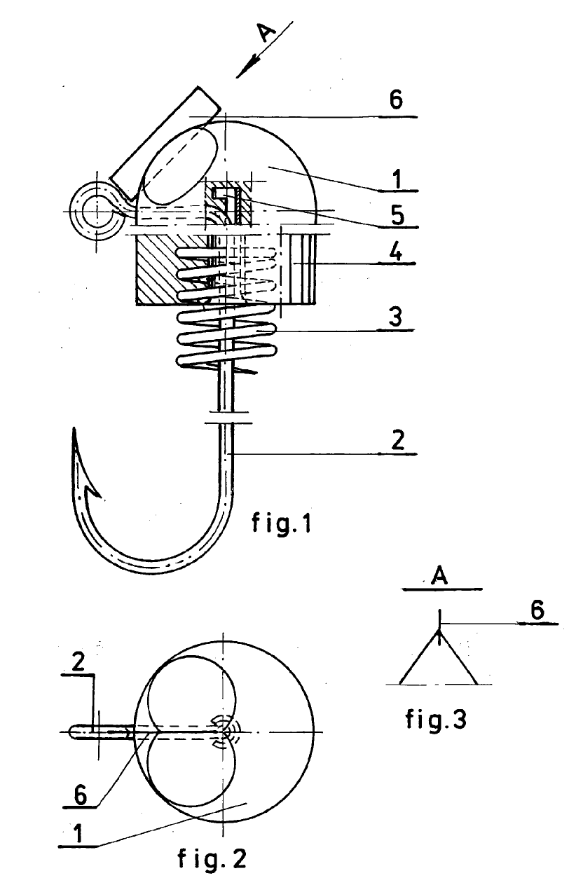

The jig head is illustrated in the attached drawings, in which FIG. 1 shows its view from the side of the blade, and FIG. 2 shows its the view from the top of the blade.

The jig head comprises two cut-off surfaces 3 and 3′ created by slicing off the spherical top of the hemisphere 1. The cut-off surfaces 3 and 3′, which are symmetric and concave, are disposed at both sides of the hook shank end.

Their size is such, that they fit within the hemisphere 1, and the angle between them is 40°. At the intersection of the cut-off surfaces 3 and 3′, disposed is a cutting blade 5 having a length slightly higher than the radius of the hemisphere 1 and extending up to the eye 4 of the hook.

The head comprises further a spring 6 which centrically embraces the hook 7. The spring 6 is at its one end fixed to the ring 8. The ring 8 is connected to the head via a bushing 9 enabling the rotation of the ring 8 with the spring 6.

1. A spherical jig head with a hook and a hook eye characterized by the fact that it comprises two symmetrical cut-off surfaces (3) and (3′) in the spherical part (1) of the spherical cap at both sides of the hook eye (4), wherein planes parallel to the cut-off surfaces intersect at an angle ranging from 65° to 30°, and a cutting blade (5) is attached at the point of their intersection.

2. The spherical jig head of claim 1 characterized by the fact that it is most advantageous for the intersection angle to range from 55° to 40°.

3. The spherical jig head of claim 1 characterized by the fact that the cut-off surfaces (3) and (3′) might be concave.

4. The spherical jig head of claim 1 characterized by the fact that the length of the cutting blade (5) is not longer than the diameter of the hemisphere (1) of the head, and that the blade it reaches up to the hook eye (4).

5. The spherical jig head of claim 1 characterized by the fact that that it might comprise further a spring (6), which spring centrically embraces the hook (7), and which spring is at its one end fixed to the bearing (8), which bearing is connected to the head via a bushing (9).
